(19) United States
(12) Patent Application Publication
(10) Pub. No.: US 2022/0389264 A1
(43) Pub. Date: Dec. 8, 2022

(54) WOOD COATING FORMULATION

(71) Applicant: Archroma IP GmbH, Reinach (CH)

(72) Inventors: Gleikon Anselmo Dos Santos Rocha, Suzano (BR); Douglas Greipel, Suzano (BR); Jorge Mayer De Oliveira, Suzano (BR)

(21) Appl. No.: 17/774,251

(22) PCT Filed: Nov. 12, 2020
(86) PCT No.: PCT/EP2020/081892

§ 371 Date: May 4, 2022

(30) Foreign Application Priority Data
Nov. 12, 2019 (EP) PCT/EP2019/081011

(51) Int. Cl. C09D 125/06; C09D 7/42; C09D 133/08; C09D 123/36; C09D 7/61; C09D 7/63; C09D 15/00

(52) U.S. Cl. CPC C09D 125/06; C09D 7/42; C09D 133/08; C09D 123/36; C09D 7/61; C09D 7/63; C09D 15/00

(57) ABSTRACT

The present application relates to a binder, a formulation for coating wood-containing substrates comprising the binder, a method for making the binder, a method for making the formulation, a method for treating the wood-containing substrate with the binder or formulation, and to the treated wood-containing substrate as such.

### FIELD OF THE INVENTION

The present application relates to a binder, a formulation for coating wood-containing substrates comprising the binder, a method for making the binder, a method for making the formulation, a method for treating the wood-containing substrate with the binder or formulation, and to the treated wood-containing substrate as such.

### BACKGROUND OF THE INVENTION

In addition to provision of aesthetic appearance, wood coatings are designed to protect the wood from weathering due to environmental influence, e.g. by preventing rapid water take-up or loss of moisture, or reduction of shrinking and swelling which can cause cracking within the wood. Weathering of wood can be caused by UV and visible light radiation, moisture and wind. In particular, the surface of wood is usually negatively affected by weathering.

Wood coating formulations protecting particularly the surface of wood from weathering are commonly known and widely available. Such formulations usually consist of the following components: resin or binder, solvent (organic solvent or water), filler (usually calcium carbonate), optionally pigments and other additives like wetting agents, defoamers, biocides or rheological modifiers. The binder or resin is usually present in an amount of about 15 to 35 wt % in the wood coating formulation. The binder or resin provides adhesion, gloss and water repellent properties to the wood and also fixes the other components, like for example the pigment to each other and to the wood.

Drawbacks of known wood coating formulations are low water resistance and low UV light radiation resistance properties. Moreover, said known wood coating formulations in general allow for a low filler content such as up to 65 wt % at the most only. This may unfavorably prolong the drying time of the coating when wood is coated with a respective formulation.

### OBJECTS OF THE INVENTION

It is an object of the present application to provide a binder as well as a wood coating formulation which overcomes the drawbacks of the state of the art compositions.

### SUMMARY OF THE INVENTION

The invention relates to the following items:
1. Binder comprising at least components (A), (B1), optionally (B2), and (C):
   (A) a polymer comprising at least the following monomer units:
      (A1) at least one monomer comprising styrene units;
      (A2) at least one monomer comprising acrylic acid ester units;
      (A3) at least one monomer comprising acrylic acid units;
      (A4) at least one olefinic monomer comprising amine groups; and
      (A5) at least one olefinic surfactant;
   (B1) at least one ionic surfactant; and
   (B2) optionally at least one non-ionic surfactant; and
   (C) water.
2. Binder according to item 1, wherein polymer (A) comprises at least the following monomer units:
   30.0 to 50.0% by weight of monomer (A1);
   45.0 to 60.0% by weight of monomer (A2);
   0.1 to 8.0% by weight of monomer (A3);
   0.1 to 8.0% by weight of monomer (A4);
   0.1 to 7.0% by weight of monomer (A5);
   based on the total amount of (A) (=100% by weight).
3. Binder according to item 1 or 2, wherein polymer (A) comprises at least the following monomer units:
   35.0 to 47.0% by weight of monomer (A1);
   47.0 to 57.0% by weight of monomer (A2);
   0.5 to 7.0% by weight of monomer (A3);
   0.2 to 7.0% by weight of monomer (A4);
   0.2 to 5.0% by weight of monomer (A5);
   based on the total amount of (A) (=100% by weight).
4. Binder according to at least one of the preceding items, wherein component (B1) is selected from a group consisting of: salts of fatty acids, alkylbenzene sulfonates such as sodium dodecylbenzene sulfonate, alkylsulfonates, fatty alcohol sulfates such as sodium lauryl sulfate, alkylether sulfates such as sodium dodecyl poly(oxyethylene) sulfate, or mixtures thereof.
5. Binder according to at least one of the preceding items, wherein component (B2) is selected from a group consisting of: polyalkylene oxide carboxylic acid esters, ethoxylated fatty alcohols, poloxamers, and alkyl polysaccharides, or mixtures thereof.
6. Binder according to at least one of the preceding items, wherein the binder comprises from
   40 to 60% by weight of (A);
   0.1 to 5.0% by weight of (B1);
   0.0 to 5.0% by weight of (B2)
   35 to 70% by weight of (C);
   based on the total amount of the binder (=100% by weight).
7. Binder according to at least one of the preceding items, wherein the binder further comprises component (D):
   (D) a compound comprising a silane group, preferably wherein the compound is an epoxy silane.
8. Binder according to item 7, wherein component (D) is present in an amount of from 0.1 to 2% by weight or 0.2 to 1.0% by weight or from 0.3 to 1% by weight based on the total amount of polymer (A) (=100% by weight).
9. Binder according to at least one of the preceding items, wherein the binder further comprises components (E), (F) and optionally one or more of components (X)
   (E) a polymer of at least one monomer comprising vinyl acetate monomer units;
   (F) at least one protective colloid
   (X) at least one tannin inhibitor.
10. Binder according to item 9, wherein polymer (E) is a homopolymer of vinyl acetate.
11. Binder according to item 9 or 10, wherein protective colloid (F) is a non-ionic water-soluble polymer, preferably selected from poly (vinyl alcohol), hydroxyethyl cellulose and poly (vinyl pyrrolidone) or mixtures thereof.
12. Binder according to at least one of the items 9 to 11 wherein tannin inhibitor (X) is selected from the group consisting of reactive pigments or salt solutions derived therefrom, such as zinc oxide, zinc ortho phosphate complex, aluminium zirconium phosphosilicate, zirconium ammonium carbonate, calcium barium phosphosilicate and barium metaborate, or mixtures thereof.
13. Binder according to at least one of items 9 to 12, wherein the binder comprises
   30 to 50% by weight of (A);
   2 to 6% by weight of (E),
   0.5 to 10% by weight of (F);
   0.02 to 4.0% by weight of (B1);
   0.0 to 4.0% by weight of (B2);
   35 to 65% by weight of (C)
   based on the total amount of the formulation (=100% by weight).
14. Formulation for coating wood-containing substrates, wherein the formulation comprises:
   (1) one or more binders according to at least one of items 1 to 8; or
   (2) one or more binders according to at least on of items 9 to 13; further
   (G) at least one plasticizer;
   (H) at least one dispersing agent;
   (I) at least one crosslinking agent;
   (J) optionally at least one pigment;
   (K) optionally at least one filler;
   (L) optionally at least one thickener;
   (X) optionally at least one tannin inhibitor;
   (Y) optionally at least one additive;
15. Formulation according to item 14, wherein plasticizer (G) is selected from phthalates and adipates of C₈ to C₁₂ alcohols, preferably di(2-ethylhexyl) adipate, diisononyl adipate, diisodecyl adipate, di(2-ethylhexyl) phthalate, diisononyl phthalate and diisodecyl phthalate, or mixtures thereof.
16. Formulation according to item 14 or 15, wherein dispersing agent (H) is a polymeric dispersant, selected from a group of polyphosphates, styrene-maleinates and polyacrylates, referably sodium polyacrylate, or mixtures thereof.
17. Formulation according to at least one of items 14 to 16, wherein crosslinking agent (I) is selected from formaldehyde, polycarboxylic acids, such as maleic acid and itaconic acid, or dialdehydes, such as glyoxal and glutaraldehyde, or mixtures thereof.
18. Formulation according to at least one of items 14 to 17, wherein pigment (J) is a white pigment, preferably selected from TiO₂, ZnO, zinc sulfide and lithopone, or mixtures thereof.
19. Formulation according to item 14 or 18, wherein filler (K) is selected from the group consisting of earth alkali metal salt of carbonate, sulfate, phosphate, clay, kaolin, preferably calcium carbonate, or mixtures thereof.
20. Formulation according to at least one of item 14 to 19, wherein thickener (L) is selected from cellulosics, hydrophobically modified alkali swellable emulsions (HASE), hydrophobically modified polyurethanes (HEUR), hydrophobically modified polyethers (HMPE), alkali swellable emulsions (ASE) as well as specialty clays, i.e. hydrated magnesium aluminosilicate, or mixtures thereof.
21. Formulation according to at least one of items 14 to 20, wherein additive (Y) is selected from additive is selected from like wetting agents, defoamers, biocides or rheological modifiers, UV stabilizers, further, wherein tannin inhibitor (X) is defined as above in item 12.
22. Formulation according to at least one of items 14 to 21, wherein the formulation comprises
   from 10 to 60% by weight of at least one binder according to at least one of the items 1 to 8; or
   from 5 to 40% by weight of at least one binder according to at least one of the items 9 to 13;
   wherein the formulation comprises further
   0.01 to 5.0% by weight of (G),
   0.1 to 5.0% by weight of (H);
   0.01 to 5.0% by weight of (I);
   0 to 20% by weight of pigment (J);
   0 to 80% by weight of filler (K),
   0 to 4.0% by weight of thickener (L);
   0 to 20% by weight of inhibitor (X);
   0 to 5.0% by weight of additive (Y);
   10 to 60% by weight of (C);
   based on the total amount of the formulation (=100% by weight).
23. Method of making a binder as defined in at least one of items 1 to 8 comprising: emulsion polymerization of compounds (A1) to (A5) in presence of component (B1), and optionally (B2), and component (C).
24. Method of making a binder as defined in at least one of claims 9 to 13 comprising: emulsion polymerization of vinyl acetate, i.e. compound (E1), in presence of component (F), (B1) and optionally component (B2), to obtain a reaction product comprising component (E) and (F), mixing the obtained reaction product with a binder according to one of claims 1 to 8.
25. Method of making a formulation as defined in items 14 to 22 comprising mixing a binder as defined in at least one of items 1 to 8, or mixing a binder as defined in at least one of items 9 to 13, with at least one plasticizer (G), at least one dispersing agent (H), at least one crosslinking agent (I), and optionally with one or more of at least one pigment (J), at least one filler (K), at least one thickener (L), at least one tannin inhibitor (X) and at least one additive (Y).
26. Method of treating a wood-containing substrate, comprising at least step (S1) followed by steps (S2) and (S3):
   (S1) contacting a wood-containing substrate with the formulation defined in at least one of the items 14 to 22; or
      contacting a wood-containing substrate with the formulation made according to item 25; or
      contacting a wood-containing substrate with the binder as defined in at least one of the items 1 to 8; or
      contacting a wood-containing substrate with the binder as defined in at least one of the one of the items 9 to 13; or
      contacting a wood-containing substrate with the binder made according to items 23 or 24;
   (S2) heat-treatment of the wood-containing substrate obtained after step (S1), preferably at a temperature of 40 to 100° C., or 50 to 80° C., or 50 to 60° C., and
   (S3) finishing the wood-containing substrate obtained after step (S2).
27. Wood-containing substrate comprising at least a binder as defined in at least one of the items 1 to 8; or
   comprising at least a binder as defined in at least one of the items 9 to 13; or
   wood-containing substrate comprising at least a formulation as defined in at least one of the items 14 to 22; or
   wood-containing substrate treated by the method according to item 26.

The binder according to the invention has the advantage that the amount of filler present in a wood coating formulation prepared therefrom can be increased up to 75% by weight based on the total weight of the formulation according to the invention. This advantageously provides for a formulation according to the invention having a beneficial drying time in wood coated with a respectively prepared wood coating formulation. Moreover, the wood coating formulation according to the invention provides for excellent water resistance and resistance against sun radiation.

### DETAILED DESCRIPTION OF THE INVENTION

First Aspect: First Binder According to the Invention

In a first aspect the invention relates to a binder comprising a polymer (A), (B1), optionally (B2), and (C) herein further also denoted as binder (1):
(A) a polymer comprising at least the following monomer units:
   (A1) at least one monomer comprising styrene units;
   (A2) at least one monomer comprising acrylic acid ester units;
   (A3) at least one monomer comprising acrylic acid units;
   (A4) at least one olefinic monomer comprising amine groups; and
   (A5) at least one olefinic surfactant;
(B1) at least one ionic surfactant; and
(B2) optionally at least one non-ionic surfactant; and
(C) water.

Component (A)

According to the invention, the binder comprises a polymer (A).

Polymer (A) is the reaction product obtained in a polymerization reaction of monomers (A1) to (A5).

Thus, component (A) is a polymer which comprises moieties derived from at least monomers (A1) to (A5).

In another embodiment, component (A) is a polymer which consists of moieties derived from at least monomers (A1) to (A5).

Monomer (A1)

According to the invention, monomer (A1) is a monomer comprising styrene units.

In a preferred embodiment, monomer (A1) consists of styrene units.

The amount of monomer (A1) present in polymer (A) is at least 30.0% by weight and at most 50.0% by weight, or at least 31% by weight and at most 49.0% by weight, or at least 32% by weight and at most 48.0% by weight, or at least 35% by weight and at most 47.0% by weight, or at least 36% by weight and at most 45.0% by weight, or at least 38.0% by weight and at most 44.0% by weight based on the total amount of component (A) (=100% by weight).

Monomer (A2)

According to the invention, monomer (A2) is a monomer comprising acrylic acid ester units, i.e. acrylate units.

In a preferred embodiment, monomer (A2) consists of acrylic acid ester units.

The term “acrylic acid ester units” encompasses the term “methacrylic acid ester units”. Thus, the term “(meth)acrylic acid ester unit” encompasses both an acrylic acid ester as well as a methacrylic acid ester or another ester substituted in α-position of the acid moiety.

In one embodiment, monomer (A2) is an acrylic acid ester CH₂═CR³COO—R² wherein R² represents a residue, i.e. the alcohol moiety of the ester, containing preferably from 1 to 40 carbon atoms.

In one embodiment, R² is a branched or unbranched or cyclic C₁ to C₄₀ alkyl group that may be saturated or unsaturated.

In a preferred embodiment, R² is selected from a branched or unbranched or cyclic C₂ to C₂₀ alkyl group, preferably from a C₄ to C₁₀ alkyl group.

In one embodiment, R³ is selected from the group consisting of H, CH₃, or C₂H₅.

In a preferred embodiment, R³ is H and R² is a C₄₋₁₀ alkyl group.

The polymer may comprise different monomer units (A2).

The amount of monomer (A2) present in component (A) is at least 45.0% by weight and at most 60.0% by weight, or at least 46.0% by weight and at most 59.0% by weight, or at least 47% by weight and at most 57.0% by weight, or at least 48% by weight and at most 56.0% by weight, or at least 46% by weight and at most 55.0% by weight, or at least 50.0% by weight and at most 54.0% by weight based on the total amount of component (A) (=100% by weight).

Monomer (A3)

According to the invention, monomer (A3) is a monomer comprising acrylic acid units.

In a preferred embodiment, monomer (A3) consists of acrylic acid units.

The term “acrylic acid” encompasses the term “methacrylic acid”. Thus, the term “(meth)acrylic acid” encompasses both an acrylic acid as well as a methacrylic acid or another acrylic acid substituted in α-position of the acid moiety.

In one embodiment, monomer (A3) is CH₂═CR³COOH, wherein R³ is selected from the group consisting of H, CH₃, or C₂H₅.

Polymer (A) may comprise different monomer units (A3).

In a preferred embodiment, monomer (A3) is methacrylic acid.

The amount of monomer (A3) present in component (A) is at least 0.1% by weight and at most 8.0% by weight, or at least 0.5% by weight and at most 7.0% by weight, or at least 0.7% by weight and at most 6.0% by weight, or at least 1.0% by weight and at most 5.0% by weight based on the total amount of component (A) (=100% by weight).

Monomer (A4)

According to the invention, monomer (A4) is an olefinic monomer containing an amine group.

In a preferred embodiment, monomer (A4) is the esterification product of an acrylic acid with an alcohol comprising an amino group.

In one embodiment, (A4) is the esterification product of acrylic acid with HO—(CH₂)ₙ—N(C₁₋₆)₂, wherein n is an integer of from 2 to 6, i.e.

CH₂═CR³C(O)O—(CH₂)ₙ—N(C₁₋₆)₂,

wherein R³ and n have the meaning as defined above.

In one embodiment, monomer (A4) is selected from diethylaminoethyl methacrylate or dimethylaminoethyl methacrylate or t-butylaminoethyl methacrylate.

The amount of monomer (A4) present in component (A) is at least 0.1% by weight and at most 8.0% by weight, or at least 0.2% by weight and at most 7.0% by weight, or at least 0.3% by weight and at most 6.0% by weight, or at least 0.4% by weight and at most 5.0% by weight, or at least 0.5% by weight and at most 4.5% by weight based on the total amount of component (A) (=100% by weight).

Monomer (A5)

According to the invention, monomer (A5) is an olefinic surfactant.

The term “olefinic surfactant” is synonymously used with the term “reactive surfactant”.

As is known in the art, that a reactive surfactant contains a polymerizable olefinic moiety that can participate in free-radical emulsion polymerization reactions. When used in an emulsion polymerization, at least a fraction of the surfactant molecules is irreversibly bound to the emulsion polymer chains and droplets.

Reactive surfactants typically consist of three moieties: a hydrophobic moiety; a hydrophilic moiety; and a polymerizable moiety, usually comprising an olefinic double bond.

Reactive surfactants are known in the art.

In one embodiment, the reactive surfactant is selected from the group consisting of: vinyl sulfonic acid, methallyl sulfonic acid or a salt thereof, allyloxy hydroxypropyl sulfonic acid or a salt thereof, allyl methoxy triethylene glycol ether, sulfopropyl acrylate, vinyl phosphate or a salt thereof, monosodium ethylsulfonate monododecyl maleate, sorbitol acrylate, sorbitol methacrylate, perfluoroheptoxy poly(propyloxy) methacrylate, phenoxyl poly(ethyleneoxy) acrylate, phenoxyl poly(ethyleneoxy) methacrylate, nonyl phenoxy poly(ethyleneoxy)crotanate, nonylphenoxy poly(ethyleneoxy)fumarate, nonyl phenoxy poly(ethyleneoxy)acrylate, nonylphenoxy poly(ethyleneoxy)methacrylate, mono dodecyl maleate, and allylsulfosuccinate derivatives, or mixtures thereof.

Vinyl sulfonic acid as monomer unit (A5) is preferred.

The amount of monomer (A5) present in component (A) is at least 0.1% by weight and at most 7.0% by weight, or at least 0.2% by weight and at most 5.0% by weight, or at least 0.3% by weight and at most 4.0% by weight, or at least 0.4% by weight and at most 3.0% by weight, or at least 0.5% by weight and at most 2.5% by weight based on the total amount of component (A) (=100% by weight).

In one embodiment, component (A) comprises or consists of, i.e. the polymer is obtained by polymerization of following monomer units:

30.0 to 50.0% by weight of monomer (A1);
45.0 to 60.0% by weight of monomer (A2);
0.1 to 8.0% by weight of monomer (A3);
0.1 to 8.0% by weight of monomer (A4);
0.1 to 7.0% by weight of monomer (A5);
based on the total amount of component (A) (=100% by weight).

Preferably, component (A) comprises or consists of, i.e. is obtained by polymerization of the following monomer units:

35.0 to 47.0% by weight of monomer (A1);
47.0 to 57.0% by weight of monomer (A2);
0.5 to 7.0% by weight of monomer (A3);
0.2 to 7.0% by weight of monomer (A4);
0.2 to 5.0% by weight of monomer (A5);
based on the total amount of component (A) (=100% by weight).

In a still more preferred embodiment, component (A) comprises or consists of, i.e. is obtained by polymerization of the following monomer units:

36.0 to 45.0% by weight of monomer (A1);
46.0 to 55.0% by weight of monomer (A2);
0.7 to 6.0% by weight of monomer (A3);
0.4 to 5.0% by weight of monomer (A4);
0.2 to 3.0% by weight of monomer (A5);
based on the total amount of component (A) (=100% by weight).

Component (B1)

Component (B1) is at least one ionic surfactant.

Ionic surfactants are known in the art.

In one embodiment, component (B1) is selected from the group consisting of: salts of fatty acids, alkylbenzene sulfonates such as sodium dodecylbenzene sulfonate, alkylsulfonates, fatty alcohol sulfates such as sodium lauryl sulfate, alkylether sulfates such as sodium dodecyl poly(oxyethylene) sulfate, or mixtures thereof.

In a preferred embodiment, the anionic surfactant is an alkali salt of sulfuric acid esterified with a fatty alcohol or fatty alcohol ethoxylate or propoxylate, i.e. a fatty alcohol sulfate or an alkylether sulfate.

The term “alkali salt of sulfuric acid esterified with a fatty alcohol or fatty alcohol ethoxylate or propoxylate, i.e. a fatty alcohol sulfate or an alkylether sulfate” encompasses the following formulas, wherein the cation preferably is a sodium cation:

CH₃—(CH₂)₁₀₋₁₆—(O—C₂H₄)₀₋₂₅—OSO₃⁻; or CH₃—(CH₂)₁₀₋₁₆—(O—C₃H₆)₀₋₂₅—OSO₃⁻.

In a preferred embodiment, said alkyl ether sulfate contains from 1 to 5 O—C₂H₄ respectively O—C₃H₆ units.

An example of an alkali alkylether sulfate is sodium dodecyl polyoxyethylene sulfate (sodium laureth sulfate; CAS no 9004-82-4).

Component (B1) is present in the binder according to the first of aspect of the invention in an amount of from 0.1 to 5.0% by weight or 0.2 to 3% by weight or 0.3 to 2% by weight based on the total amount of the binder according to the first aspect of the invention (=100% by weight).

Component (B2) (Optional)

Component (B2) is at least one non-ionic surfactant.

Non-ionic surfactants are known in the art.

In one embodiment, component (B2) is selected from the group consisting of:

polyalkylene oxide carboxylic acid esters, ethoxylated fatty alcohols, poloxamers, and alkyl polysaccharides, or mixtures thereof.

Preferred non-ionic surfactants are ethoxylated fatty alcohols.

Component (B2) is present in the binder according to the invention in an amount of from 0.0% to 5% by weight or from 0.1% to 4% by weight or from 0.2% to 3% by weight or from 0.3% to 2% by weight based on the total amount of the binder (=100% by weight).

Component (C)

The binder according to the invention is based on water. That means component (C) comprises water. This, however, does not exclude the presence of organic solvents.

Thus, in one embodiment, the binder according to the invention is based on water or on water and an organic solvent.

The term “based on water or on water and an organic solvent” encompasses solutions, emulsions and dispersions of the solid and/or liquid compounds contained in the binder in water solvent. The terms “solutions”, “emulsions” and “dispersions” are used interchangeably.

In one embodiment component component (C) consists of water.

The term “water” encompasses distilled water as well as pipe water.

The term “organic solvent” preferably encompasses solvents which are miscible with water or are partially water soluble. Preferred organic water miscible solvents are C₁₋₂ alcohols, glycols such as ethylene glycol and propylene glycol, dipropylene glycol or polyethylene glycols, amides such as N-methylformamide and N,N-dimethylformamide.

Partially water-soluble solvents are also suitable. Preferred organic solvents are dipropylene glycol dimethylether, methoxy propyl acetate, methoxy butyl acetate (butoxyl), and methoxy methyl butyl acetate.

Preferably, the binder according to the invention is mainly based on water. The term “mainly” means that the amount of organic solvent is less than 50% by weight, based on the total weight of water and organic solvent (=100% by weight). In a preferred embodiment, the amount of organic solvent is less than 40% by weight; more preferred less than 30% by weight, still more preferred less than 20% by weight, still more preferred less than 10% by weight. In one embodiment, the binder does not contain an organic solvent.

The binder according to the invention may contain from 35% to 90% by weight water or water and an organic solvent based on the total amount of the binder (=100% by weight).

In a preferred embodiment, the binder contains from 35 to 65% by weight or from 35 to 70% by weight water, based on the total amount of the binder (=100% by weight).

Preferably, the binder according to the first aspect of the invention comprises or consists of

40 to 60% by weight of (A);
0.1 to 5.0% by weight of (B1);
0.0 to 5.0% by weight of (B2)
35 to 70% by weight of (C);
based on the total amount of the binder (=100% by weight).

According to the invention, as disclosed below, the binder is prepared by emulsion polymerization of components (A1) to (A5), in the presence of components (B1) and (C) and optionally component (B2).

In one embodiment, the binder is prepared by emulsion polymerization in presence of one or more further additives. Suitable additives are known in the art.

Component (D)

In one embodiment, the binder further comprises (D):

(D) a compound comprising a silane group.

Compound (D) may act as an adhesion promoter.

Compound (D) may be present in an amount of from 0.1 to 2% by weight or 0.2 to 1.0% by weight or from 0.3 to 1% by weight based on the total amount of polymer (A) (=100% by weight).

In a preferred embodiment, compound (D) is an epoxy silane.

Suitable epoxy-functional silanes for use in the present invention include silanes having the formula

R₁Si(R₂)₃₋ₙ(OR₃)ₙ,

wherein n is 1, 2, or 3, R₁ is alkyl, cycloalkyl, phenyl, cycloalkylalkyl, alkenylcycloalkyl, alkenylphenyl, or phenylalkyl, wherein the R₁ group contains at least one epoxy group, each R₂ is independently hydrogen, alkyl, cycloalkyl, phenyl, cycloalkylalkyl, alkenylcycloalkyl, alkenylphenyl, phenylalkyl, or a silane oligomer, wherein each R₂ group can optionally include OR₃ groups or epoxy functionality. Each R₃ group is independently hydrogen, alkyl, cycloalkyl, phenyl, cycloalkylalkyl, alkenylcycloalkyl, alkenylphenyl, or phenylalkyl.

The term “alkyl” as used in connection with the above silane encompasses C₁-C₂₀ alkyl, the term “cycloalkyl” encompasses C₁-C₂₀ cycloalkyl, and the term “alkenyl” encompasses C₁-C₂₀ alkenyl.

Exemplary epoxy-functional silanes include 2-(3,4-epoxycyclohexyl)-ethyltrimethoxysilane), 3-glycidoxypropyltrimethoxysilane, 3-glycidoxypropylmethyldiethoxysilane, 3-glycidoxypropyltriethoxysilane, 3-glycidoxypropylmethyldiethoxysilane, 3-glycidylpropyl triethoxysilane.

Further additives which may be present are selected from biocides and defoamers. Suitable products are known in the art.

In one further embodiment the binder according to the invention further comprises components (E), (F) and optionally component (X) and is herein further also denoted as binder (2)
(E) a polymer of at least one monomer comprising vinyl acetate monomer units;
(F) at least one protective colloid;
(X) optionally at least one tannin inhibitor.

Component (E)

In one embodiment of the invention, polymer (E) is the reaction product obtained in a polymerization reaction of vinyl acetate monomer units (E1).

In one further embodiment of the invention, the amount of monomer (E1) present in polymer (E) is 100% by weight. In one embodiment polymer (E) is made by homopolymerization of monomer units of vinyl acetate (E1).

Component (F)

Component (F) comprises or consists of at least one protective colloid.

The protective colloid of component (F) stabilizes the dispersions, obtained by emulsion polymerization, e.g. as described above, to prevent coagulation of the therewith obtained particles, e.g. the polymer particles.

In one embodiment component (F) is selected from non-ionic water-soluble polymers such as poly (vinyl alcohol), hydroxyethyl cellulose and poly (vinyl pyrrolidone), or mixtures thereof.

Suitable polyvinyl alcohols are partly or fully hydrolysed polyvinyl alcohols. Preference is given to partly or fully hydrolysed polyvinyl alcohols having a degree of hydrolysis of from 80 to 100 mol %, especially to partly hydrolysed polyvinyl alcohols having a degree of hydrolysis from 80 to 95 mol %, preferably 85 to 92 mol %, or 87-89 mol %, and a Höppler viscosity, in 4% by weight aqueous solution, of from 1 to 30 mPas (Höppler method at 20° C., DIN 53015).

In one embodiment, component (F) is present in the binder according to the invention in an amount of from 0.5% to 10% by weight or from 0.5% to 8% by weight or from 0.5% to 5% by weight based on the total amount of the binder (=100% by weight).

In a preferred embodiment, component (F) is a poly (vinyl alcohol).

Component (X) (Optional)

Component (X) comprises or consists of at least one tannin inhibitor.

The tannin inhibitor of component (X) avoids tannin migration to the coating surface.

A problem in wood coating is the leaching of tannin from the wood resulting in tannin stains on the coated surface. Tannins are complex chemical substances derived from phenolic acids (sometimes called tannic acid), that occurs naturally in all wood and plant materials. Phenolic compounds are chemically defined as compounds containing hydroxylated aromatic rings, the hydroxy group being attached directly to the phenyl, substituted phenyl, or other aryl group. As such, to avoid tannin staining on coating, additives to block or inhibit tannin leachate can also be added. Tannin inhibitors are designed to react with soluble tannins to form insoluble complexes which do not migrate into the topcoat.

In one embodiment the tannin inhibitor component (X) is selected from the group consisting of reactive pigments or salt solutions derived therefrom, such as zinc oxide, zinc ortho phosphate complex, aluminium zirconium phosphosilicate, calcium barium phosphosilicate, barium metaborate.

Tannin inhibitor (X) is optionally present in the binder according to the invention in an amount of from 0 to 20% by weight, preferably of from 1 to 15% by weight, or 2 to 13% by weight, or 2 to 10% by weight based on the total weight of the binder according to the invention (=100% by weight).

In one further embodiment of the invention the binder comprises

30 to 50% by weight of (A);
2 to 6% by weight of (E);
0.5 to 10% by weight of (F);
0.02 to 4.0% by weight of (B1);
0.0 to 4.0% by weight of (B2);
35 to 65% by weight of (C);
based on the total amount of the formulation (=100% by weight).

Second Aspect: Formulation According to the Invention

In a second aspect, the invention relates to a formulation for coating wood-containing substrates.

The formulation according to the invention comprises at least binders (1) or (2) as defined above with reference to the first aspect of the invention, and further comprises (G), (H), (I), and optionally comprises one or more of components (J), (K), (L), and (X). Accordingly, the formulation for coating wood-containing substrates according to the invention comprises:
one or more binders (1) or (2) according to the first aspect of the invention;
(G) at least one plasticizer;
(H) at least one dispersing agent;
(I) at least one crosslinking agent;
(J) optionally at least one pigment;
(K) optionally at least one filler;
(L) optionally at least one thickener;
(X) optionally at least one tannin inhibitor
(Y) optionally at least one additive.

The formulation according to the invention has the advantage that although significantly higher amounts of a filler are present in the formulation according to the invention nevertheless the anchorage on the wood-containing substrate is good. Further, the formulation according to the invention has the advantage of providing an improved water resistance and UV light resistance to the therewith treated wood-containing substrate. Also, the formulation according to the invention has the advantage that re-emulsification after water immersion is increased to 10 to 12 h.

In particular, the increased water resistance has to be mentioned. The usual market products normally resist to re-emulsification no longer than 20 min as is shown in the examples. This enhanced property enables the formulation according to the invention to be used both indoor as well as outdoor.

The formulation comprising binder (1) or (2) according to the first aspect of the invention, provides dispersions with a controlled particle size, excellent storage stability and filler acceptance to be used in wood coating formulations to render smoothness and excellent water resistance and better adhesion on the final finishing are achieved.

Particle size is measured by DLS (Dynamic Light Scattering) technique.

Preferably, the binder (1) and binder (2) according to the first aspect of the invention have particle sizes of from 180 to 300 nm such as 250 nm. The particle size distribution is commonly monomodal around 250 nm.

The solids content is measured by placing a sample in an oven at a temperature of 105° C. until a steady mass is obtained. The solids content of binder (1) or binder (2) according to the first aspect of the invention or the formulation according to the second aspect of the invention maybe adjusted (e.g. by addition of filler or pigments) in the range of 10 to 80% by weight, or 20 to 70% by weight, or 30 to 60% by weight, or up to 80% by weight, or up to 75% by weight, or up to 70% by weight, or up to 65% by weight, or in the range of 65 to 80% by weight, or in the range of 70 to 80% by weight, or in the range of 75 to 80% by weight based on the total amount of binder (1) or binder (2).

Component (G)

Component (G) comprises or consists of at least one plasticizer.

Plasticizers may be added during or after polymerization. These plasticizers aid in film coalescence and flexibility by decreasing the glass transition temperature Tg of the polymer.

In one embodiment of the invention according to the second aspect component (G) is selected from phthalates and adipates of C₈ to C₁₂ alcohols, preferably di(2-ethylhexyl) adipate, diisononyl adipate, diisodecyl adipate and diisodecyl phthalate, or mixtures thereof.

Examples of plasticizers include adipates of C₈ alcohol, C₉ alcohol, C₁₀ alcohols, C₁₁ alcohols, C₁₂ alcohols for example di(2-ethylhexyl) adipate, diisononyl adipate and diisodecyl adipate and phthalates of C₈ alcohol, C₉ alcohol, C₁₀ alcohols, C₁₁ alcohols, C₁₂ alcohols, for example, di(2-ethylhexyl) phthalate, diisononyl phthalate, and diisodecyl phthalate, or mixtures thereof.

Component (H)

Component (H) comprises or consists of at least one dispersing agent.

The dispersing agent effects the suspending of hydrophobic particles in aqueous media. Dispersing agents are surface-active chemicals that have a solvating action on the material to be dispersed and thus help to maintain a state of dispersion by preventing settling or aggregation.

Usually, dispersing additives provide stabilization by two main stabilization mechanisms: electrostatic or steric stabilization.

In terms of chemical structure one can divide dispersing agents into the two following classes: surfactants, also called low molecular weight dispersing agents and polymeric dispersants, also called high molecular weight dispersants.

Component (H) may be a polymeric dispersant, selected from a group of polyphosphates, styrene-maleinates and polyacrylates, preferably sodium polyacrylate, or mixtures thereof.

Component (I)

Component (I) comprises or consists of at least one crosslinking agent.

Crosslinking reactions are one of the most commonly used techniques to improve physical properties of the polymer. Cross-linking agents can be used to increase the rigidity of the polymer and to enhance the resistance to moisture.

Crosslinking improves physical properties of the polymer (A) and (E) used in binder (1) or (2) according to the first aspect of the invention. Cross-linking agents can be used to increase the rigidity of the polymer and to enhance the resistance to moisture. Suitable crosslinkers used according to the invention for these reactions are di-functional compounds, such as glutaraldehyde and glyoxal. Crosslinking agent (I) may be also selected from formaldehyde, polycarboxylic acids, such as maleic acid and itaconic acid.

In one embodiment of the formulation according to the invention, crosslinking agent (I) is selected from polycarboxylic acids, such as maleic acid and itaconic acid, formaldehyde, or dialdehydes such as glyoxal and glutaraldehyde, or mixtures thereof.

In a further preferred embodiment, the formulation comprises at components (J), (K), (L), and (X).

Component (J) (Optional)

Component (J) comprises or consists of at least one pigment.

Usually, pigments may be incorporated in the binder.

In a preferred embodiment, the pigment (J) is a white pigment.

In a preferred embodiment, pigment (J) is a white pigment, preferably selected from TiO₂, ZnO, zinc sulfide and lithopone, or mixtures thereof. Lithophone is a mixed pigment produced from zinc sulfide and barium sulfate. Titanium dioxide, TiO₂, is by far the most suited white pigment to obtain whiteness and hiding power in coatings because of its high refractive index.

Component (K) (Optional)

Component (K) comprises or consists of at least one filler.

In one embodiment, fillers are selected from inorganic salts which are not soluble in the binder such as sulfates, phosphates and carbonates, or mixtures thereof, wherein the cation preferably is selected from earth alkali metals such as calcium.

In a preferred embodiment, the filler is calcium carbonate.

In another embodiment, the filler is selected from the group consisting of clay or kaolin.

Component L (Optional)

Component (L) comprises or consists of at least one thickener (L).

(L) is selected from cellulosics, hydrophobically modified alkali swellable emulsions (HASE), hydrophobically modified polyurethanes (HEUR), hydrophobically modified polyethers (HMPE), alkali swellable emulsions (ASE) as well as specialty clays, i.e. hydrated magnesium aluminosilicate, or mixtures thereof. Preferably HASE thickeners are used to achieve the desirable rheological alternatives.

In one embodiment of the formulation according to the invention, the thickener may be selected from an acrylic thickener.

Component (Y) (Optional)

Component (Y) comprises or consists of at least one additive (Y).

In one embodiment of the formulation according to the invention the at least one additive is selected from wetting agents, defoamers, biocides or rheological modifiers, UV stabilizers.

Component (X) which is optionally present in the formulation according to the second aspect of the invention is the same as defined above with respect to the binder according to the first aspect of the invention.

According to the second aspect of the invention the formulation comprises:
from 10 to 60% by weight of at least one binder (1) as defined above with reference to the first aspect of the invention; or
from 5 to 40% by weight of at least one binder (2) as defined above with reference to the first aspect of the invention;
wherein the formulation comprises further
0.01 to 5.0% by weight of (G);
0.1 to 5.0% by weight of (H);
0.01 to 5.0% by weight of (I);
0 to 20% by weight of pigment (J)
0 to 80% by weight of filler (K),
0 to 4.0% by weight of thickener (L);
0 to 20% by weight of tannin inhibitor (X);
0 to 5% by weight of additive (Y);
10 to 60% by weight of (C);
based on the total amount of the formulation (=100% by weight).

The amount of binder (2) present in the formulation according to the invention is at least 5% by weight and at most 40% by weight, or at least 10% by weight and at most 35% by weight, or at least 20% by weight and at most 30% by weight, based on the total amount of the formulation according to the invention (=100% by weight). The amount of binder (1) present in the formulation according to the invention is at least 10% by weight and at most 60% by weight, or at least 15% by weight and at most 55% by weight, or at least 20% by weight and at most 40% by weight, based on the total amount of the formulation according to the invention (=100% by weight).

Plasticizer (G) is present in the formulation according to the invention in an amount of from 0.01% to 5% by weight or from 0.01% to 4% by weight or from 0.01% to 3% by weight or from 0.01% to 2% by weight based on the total amount of the formulation (=100% by weight).

Dispersing agent (H) is present in the formulation according to the invention in an amount of from 0.1% to 5% by weight or from 0.1% to 4% by weight or from 0.2% to 3% by weight or from 0.3% to 2% by weight based on the total amount of the formulation (=100% by weight).

Crosslinking agent (I) is present in the formulation according to the invention in an amount of from 0.01% to 5% by weight or from 0.01% to 4% by weight or from 0.01% to 3% by weight or from 0.01% to 2% by weight based on the total amount of the formulation (=100% by weight).

Pigment (J) is optionally present in the formulation according to the invention in an amount of from 0 to 20% by weight, or from 0 to 10% by weight, preferably of from 5 to 10% by weight, based on the total amount of the formulation (=100% by weight).

Filler (K) is optionally present in the formulation according to the invention in an amount of from 0 to 80% by weight, preferably up to 75% by weight, preferably up to 65% by weight, or up to 59% by weight, or up to 58% by weight, or up to 57% by weight, and/or in an amount of at least 50% by weight, preferably at least 55% by weight, preferably at least 60% by weight, preferably at least 65% by weight, preferably at least 70% by weight, preferably at least 75% by weight based on the total weight of the formulation according to the invention (=100% by weight).

Thickener (L) is optionally present in the formulation according to the invention in an amount of from 0 to 4.0% by weight, preferably of from 0.1 to 3% by weight, or 0.5 to 3.0% by weight, or 1 to 2.5% by weight based on the total weight of the formulation according to the invention (=100% by weight).

Tannin inhibitor (X) is optionally present in the formulation according to the invention in an amount of from 0 to 20% by weight, preferably of from 1 to 15% by weight, or 2 to 13% by weight, or 2 to 10% by weight based on the total weight of the formulation according to the invention (=100% by weight).

Additive (Y) is optionally present in the formulation according to the invention in an amount of from 0 to 5% by weight, preferably of from 0.1 to 4% by weight, or 0.2 to 4% by weight, or 1 to 3% by weight based on the total weight of the formulation according to the invention (=100% by weight).

Component (C) is present in the formulation according to the invention in an amount of from 10 to 60% by weight, preferably of from 10 to 55% by weight, or 10 to 45% by weight, or 15 to 30% by weight based on the total weight of the formulation according to the invention (=100% by weight). In one embodiment of the formulation according to the invention component (C) is additionally added to the formulation according to the second aspect of the invention, independently of the fact if it is already present in binder (1) or (2) according to the first aspect of the invention. In any case, the amount of component (C) present in the formulation according to the invention is present at most in the amounts as defined in the beginning of this paragraph. Component (C) which is present in the formulation according to the second aspect of the invention is the same as defined above with respect to the binder according to the first aspect of the invention.

Method of Making the Binder (1) According to the First Aspect of the Invention

The invention relates further to a method of making the binder (1) according to the first aspect of the invention.

The method of making the binder (1) according to the first aspect of the invention is an emulsion polymerization.

According to the invention, the method comprises emulsion polymerization of compounds (A1) to (A5) in presence of component (B1), optionally component (B2), and component (C) as defined in the first aspect.

Emulsion polymerization is a well-known technique for producing polymers. Typically, monomers are polymerized in aqueous medium under the influence of an initiator such as a persulfate, and in the presence of a suitable surfactant. The surfactant may be a non-ionic, an anionic or a cationic surfactant. Stabilizers such as polyvinyl alcohol and other water-soluble polymers may be added in order to promote emulsion polymerization. Other ingredients include chain transfer agents, buffering agents, and inert salts. Preservatives may be added to products sold as liquid dispersions to retard bacterial growth. These are usually added after polymerization.

There are essentially three options for conducting emulsion polymerization:

In a first option, in a dosage type, a small amount of initiator and monomers, usually in an amount of 5 to 10% by weight, are heated up before the initial reaction temperature is reached. After onset of the reaction, the rest of initiator and monomers are metered. However, the reaction may also be performed such that a small amount of the initiator in water is provided in a reactor, and monomers and the remainder of the initiator are separately and simultaneously metered into the reactor.

In a second option, in a semi-batch type, an aqueous phase is charged with initiator and about 50% by weight of the monomers. After polymerization of this amount, the remainder is metered by dosage, or, after cooling down again, in a batch-wise manner.

In a third option, in a batch type, the whole amount of initiator and monomers are charged, and the reaction is started by heating up. Subsequently, the reaction heat is removed using e.g. a heat exchanger.

For safety reasons, frequently, in emulsion polymerizations, the dosage type is preferred, i.e., a minor portion of the initiator is provided in water, and subsequently separated feeds of a pre-emulsion of the monomers and surfactants and the major portion of the initiator are slowly and simultaneously but separately added in order to provide a controlled reaction.

Without being bound by theory it is believed that the polymerization reaction takes place in micelles in which the monomer droplet is stabilized by surfactants. The surfactants, usually an anionic or a combination of an anionic and nonionic surfactant. Anionic surfactants provide shear stability to prevent loss due to coagulation. Nonionic surfactants provide electrolyte or chemical stability to the growing latex particles

Olefinic surfactants (A5), also referred to herein as “reactive surfactant”, act in emulsion polymerization both as a surfactant and as a co-monomer. Usually, emulsion stabilization is their main objective, and the ability of copolymerization is an extra advantage.

Reactive surfactants have the ability to covalently bind to the dispersed phase. As result they cannot be displaced from the interface as easily as traditional surfactants, which are only physically bonded.

Reactive surfactants simply build into polymer structure and does not remain in reaction mixture. In this way, it prevents migration of the surfactant (“non-migratory” surfactant) to the interface (polymer/air and polymer/substrate) in films formed of the latex. It results in better properties of the coating and reduces water sensitivity; it also improves adhesion and gloss.

In a preferred embodiment, the binder (1) according to the first aspect of the invention is prepared by polymerizing monomers (A1) to (A5), thus forming component (A), in component (C), being water or water and an organic solvent and in the presence of component (B1), and optionally component (B2).

In a preferred embodiment, prior to polymerization, a mixture of monomers (A1) to (A5), component (B1), and optionally (B2), in water or water and an organic solvent (C) is homogenized. This method is exemplarily explained below:

A stable monomer pre-emulsion is prepared by adding monomers (A1) to (A5) to the vigorously stirred aqueous phase. This process involves emulsification of the relatively hydrophobic free-radically polymerizable, ethylenically unsaturated monomers in water by an oil-in-water surfactant (B1) and optionally (B2).

In one embodiment, the initial reactor charge is heated to 65° C.-75° C. When the temperature is reached part of the pre-emulsion, usually 3% to 10% by weight of the pre-emulsion is added to the reactor.

When this first charge has polymerized, the remainder of the monomer pre-emulsion is gradually added over a period of 3 to 5 hours. The initiator solution is added simultaneously via separate line.

The most common water-soluble initiators used are potassium, sodium and ammonium salts of persulfates. Next in line, are the water-soluble azo compounds, especially those with an ionic group, such as 2,2′-azobis(2-amidinopropane)dihydrochloride.

The amount of initiator employed may be in the range of from 0.1 to 2.0% by weight, based on the mixture of the monomer (A1) to (A5) (=100% by weight), preferably 0.1 to 1.5% by weight.

Typically, the reaction temperature is maintained at a temperature lower than 95° C. throughout the course of the reaction. Preferred is a reaction temperature between 50° C. and 95° C., more preferably between 60° C. and 90° C.

The process for the emulsion polymerization generally ends, for example after the optional post-heating, after a polymerization of up to 99% of the monomers, based on the total weight of all components, particularly preferably after up to 99.5% of the monomers, based on the total weight of all components.

At the end of the polymerization process, a milky fluid termed “latex, synthetic latex or polymer dispersion” is obtained. Latex is defined as colloidal dispersion of polymer particles in an aqueous medium.

In one embodiment, the emulsion polymerization may be carried out according to the following protocol:

Reactor Preparation

The aqueous phase is prepared in the solution vessel. Process water is charged to the vessel and emulsifier or protective colloid (in solid or liquid form) is added through the manhole. Afterwards the vessel is heated to 70-80° C. via jacket and/or by direct steam injection to dissolve the products in water.

Pre-Emulsion

The monomers (according to product type) are either charged from storage tanks or (in case of small quantities) from drums to the pre-emulsion vessel. After addition of water and emulsifiers, an aqueous water-monomer emulsion is created with a fast running agitator.

Initiator Solution

An aqueous initiator solution is prepared by common methods. The initiator is added either to the top of the reactor during addition of monomers with the pre-emulsion stream.

Polymerization—Main Reaction

The content of the reactor is heated to about 60-85° C. to start polymerization. The reaction itself is running at temperatures from 70 to almost 90° C. at ambient pressure.

The heat of polymerization has to be removed either by condensation of the boiling azeotropic mixture of monomers and water in the reflux condenser or/and with jacket/half coil cooling.

After polymerization is finished (4 to 8 hours), usually a post reaction at slightly higher temperature is carried out to reduce residual monomer content. To some grades a redox system is added at lower temperatures for further reduction of residual monomer content.

After the batch is cooled down to a certain temperature (depending on the product), the batch is transferred by compressed air or a positive displacement pump through a coarse filter into one of two adjusting vessels.

Final Adjustments

In the adjusting vessels the cooling is continued and the properties of the finished products (such as solid content, viscosity, pH value, etc.) are adjusted according to the specifications.

Filtration and Packaging

After final analysis the adjusted product is transferred with a positive displacement pump or compressed air through a fine filter to finished good storage tanks or filling station or to further processing tanks.

Method of Making the Binder (2) According to the First Aspect of the Invention

The invention relates to a method of making the binder (2) according to the first aspect of the invention.

Aqueous dispersions of polyvinyl acetate ordinarily called polyvinyl acetate emulsions are made by dispersing monomeric vinyl acetate in water.

The method of making the binder (2) according to the first aspect of the invention is based on emulsion polymerization process as explained above for binder (1).

According to the invention, the method comprises emulsion polymerization of vinyl acetate monomer (E1) at least in presence of component (F) and optionally in the presence of component (B1) and/or (B2).

Prior to polymerization, vinyl acetate monomer (E1) is provided in a separate vessel for a dosing process. This method is explained below:

In a preferred embodiment, prior to polymerization, a solution of component (F) is prepared in a separate vessel and is transferred to a reactor vessel. Optionally, a solution of component (B1) and/or component (B2) is additionally charged into the reactor vessel. In one embodiment thereof, at least charging of component (B1) into the solution of component (F) is mandatory, whereas charging of component (B2) remains optional.

The initial reactor charge of the solution comprising component (F) and optionally component (B1) and/or (B2) is heated to 65° C.-75° C. When the temperature is reached, part of the vinyl acetate monomer (E1), usually 3% to 10% by weight of the total weight of the vinyl acetate monomer provided in the dosing vessel, is added to the reactor.

Polymerization is started by adding a radical initiator. When this first charge is polymerized, the remainder of the vinyl acetate monomer (E1) is gradually added over a period of 3 to 5 hours simultaneously together with an initiator solution which is added via separate line.

The most common water-soluble initiators suited for the polymerization are potassium, sodium and ammonium salts of persulfates and water-soluble azo compounds, especially those with an ionic group, such as 2,2′-azobis(2-amidinopropane)dihydrochloride.

After polymerization is completed, the batch is cooled down to 35° C., the batch is transferred by compressed air or a positive displacement pump through a coarse filter into an adjusting vessel.

In the adjusting vessels the cooling is continued, and binder (1) according to the first aspect of the invention (and as produced according to the method described above ((“Method of making the binder (1) according to the first aspect of the invention”)) is transferred by compressed air or a positive displacement pump through a coarse filter into the adjusting vessel.

Component (X) is optionally added to the adjusting vessel and mixed with the ingredients of the adjusting vessel. The properties of the finished binder (2) such as solid content, viscosity is adjusted according to desired specifications. Final adjustments may include addition of further component (F).

After final adjustments, filtration and packaging follow according to the preparation of the first binder.

As can be derived from the above described method for manufacturing binder (2) according to the invention, binder (2) is a product comprising or consisting of two components: 1. binder (1) according to the first aspect of the invention and as manufactured according to the method described above (“Method of making the binder (1) according to the first aspect of the invention”) and 2. an emulsion polymerization product of components (E1) in presence of (F) and optionally in presence of (B1) and/or (B2) obtained according to the herein described method (“Method of making the binder (2) according to the first aspect of the invention”).

The weight ratio of above mentioned components 1 (i.e. binder (1)) and 2 (i.e. reaction product of emulsion polymerization product of components (E1) in presence of (F) and optionally in presence of (B1) and/or (B2)) is preferably in the range of 2.5 to 16% by weight of component 2 (i.e. reaction product of emulsion polymerization product of components (E1) in presence of (F) and optionally in presence of (B1) and/or (B2)) to component 1 (i.e. binder (1)) 97.5 to 84% by weight such that the sum of both components in binder (2) sums up to 100% by weight. The above ratio can also be expressed differently, namely by listing all components which are present in binder (2) and consequently also the components of binder (1) by % by weight as done above in the description of binder (2) according to the first aspect of the invention (see e.g. item 13).

Method of Making the Formulation According to the Invention

The invention further relates to a method of making a formulation according to the invention as defined in the second aspect:

Binder (1) or binder (2) according to the first aspect of the invention is mixed with at least one plasticizer (G), at least one dispersing agent (H), at least one crosslinking agent (I), and optionally with one or more of at least one pigment (J), at least one filler (K), at least one thickener (L), at least one tannin inhibitor (X) and at least one additive (Y).

For application, this formulation may be further modified by adding a further pigment or filler such as a calcium carbonate.

Use of the Binder According to the Invention as Defined in the First Aspect and Use of the Formulation According to the Invention as Defined in the Second Aspect

The invention relates further to the use of the binder (1) or binder (2) according to the invention as defined in the first aspect and use of the formulation according to the invention as defined in the second aspect. In particular, the respective use of said binder (1) or (2) or said formulation relates to a method of treating a wood-containing substrate comprising at least step (S1) followed by steps (S2) and (S3). Said method is described in the following in more detail:

Step (S1) relates to contacting a wood-containing substrate with the formulation according to the invention; or contacting a wood-containing substrate with the formulation made according of the invention; or contacting a wood-containing substrate with binder (1) or binder (2) according to the first aspect of the invention; or contacting a wood-containing substrate with the binder made according to the methods of the invention described above.

The term “wood-containing substrate” as used within the context of the present application is to be understood as substrate comprising or consisting of wood. The term further encompasses substrates comprising or consisting of timber. The term “timber” as used within the context of the present application is to be understood in that timber has already been subjected to some kinds of physical or chemical treatments, such as drying procedures, sawing procedures, pressing procedures or the like. This means that the term “wood” as used within the context of the present application refers to subjects comprising or essentially consisting of cellulose and hemicelluloses, and lignin. The wood-containing substrate can comprise, in addition to wood, further components, like glue. The wood-containing substrate can be designed as solid wood or as wood-containing composite, wherein the wood-containing composite can be fiber-based, particle-based, or veneer-based. In particular, if the wood-containing substrate is designed as wood-containing composite which is fiber-based, particle-based, or veneer-based, further components such as glue can be present.

The contacting of the wood-containing substrate may be carried out by generally customary methods, such as dunking or dipping the substrate into the formulation according to the invention or the binder according to the invention, or by spraying the formulation according to the invention or the binder according to the invention onto a wood-containing substrate, or by brush application or sponge application or via a forced application or by an extraction method.

In a preferred embodiment, the wood is coated through an extruder machine. The machine is equipped with a hard steel gesso box for extruding gesso on molding.

Step (S2) relates to a heat-treatment of the wood-containing substrate obtained after step (S1), preferably at a temperature of 40 to 100° C., or 50 to 80° C., or 50 to 60° C., or wherein the material is dried with the use of an oven in a temperature of 55-70° C.

Step (S3) relates to the finishing of the wood-containing substrate obtained after steps (S1) and (S2) such as a sanding process.

A wood-containing substrate treated with formulation according to the invention or the binder according to the invention has improved UV light resistance, water resistance, but at the same time a glossy and smooth finishing. With the possibility of accepting a higher amount of filler in the coating preparation, it was observed a better coverage, including hiding natural defects of wood such as knots.

Third Aspect: Wood-Containing Substrate

The third aspect of the invention relates to a wood-containing substrate comprising at least a binder (1) or binder (2) according to the first aspect of the invention. The third aspect further relates to a wood-containing substrate comprising at least a formulation according to the second aspect of the invention. The third aspect also relates to a wood-containing substrate treated by the methods according to the invention described above.

### EXAMPLES

### Example 1: Preparation of the Binder (1) According to the First Aspect of the Invention

A pre-emulsion vessel was charged with 2200 liters of water. A solution of 45 kg sodium lauryl ether sulfate (2EO) 27% in 90 liters water was added under stirring. Then 2,476 kg of styrene, 2,322 kg of butyl acrylate and 103 kg of methacrylic acid were added and the pre-emulsion was homogenized. Finally, 51 kg of 2-dimethylaminoethyl methacrylate and 206 kg of sodium vinyl sulfonate were added.

A reaction vessel was charged with 1.330 kg of demineralized water. To the reaction vessel 55 kg sodium lauryl ether sulfate (2EO) was added. The reactor was heated up to 73-75° C. Subsequently, 475 kg of the pre-emulsion previously prepared were added. The temperature was adjusted to 70-72° C.

13.7 kg of ammonium persulfate were dissolved in 340 kg of demineralized water.

The pre-emulsion and the initiator solution were metered separately but simultaneously within a time period of about 4 hours to the stirred content of the reaction vessel while the temperature was kept in a range of from 83 to 87° C. Subsequently, it was stirred for another hour.

The reaction mixture was cooled down to 80° C.

Subsequently, another initiator solution of 7.1 kg of ammonium persulfate in 160 liters water was added.

The reaction was cooled down to 35° C. and terminated.

Finally, 31.6 kg of an epoxy silane in 90 liters water were added as well as a biocide and defoamer to adjust to the final specification. Water was added in order to adjust the solids content to about 50% by weight, based on the total amount of the composition.

### Example 2: Preparation of Binder (2) According to the First Aspect of the Invention

The dosing vessel was charged with 2400 kg of vinyl acetate. A previous prepared solution of 200 kg of polyvinyl alcohol in 1800 liters of demineralized water was transferred to the reactor. A solution of 8 kg sodium lauryl sulfate 30% in 5 liters water was added under stirring. The reactor was heated up to 65-70° C.

Then 100 kg of vinyl acetate from the dosing vessel was transferred to the reaction vessel and an initiator solution of 2.0 kg of ammonium persulfate in 15 liters of water was added to start polymerization reaction.

The monomer and the initiator solution of 4 kg ammonium persulfate in 100 liters of water were metered separately but simultaneously within a time period of about 4 hours to the stirred content of the reaction vessel while the temperature was kept in a range of from 78 to 88° C. Subsequently, it was stirred for another hour.

The reaction mixture was cooled down to 75° C.

Subsequently, another initiator solution of 1 kg of ammonium persulfate in 17 liters water was added.

The content of the reaction vessel was stirred for another hour at 70-75° C. For viscosity adjustment a polyvinyl alcohol solution is prepared accordingly in a separate vessel and added to the homopolymer dispersion.

The reaction was cooled down to 35° C. The reaction product is transferred by compressed air or a positive displacement pump through a coarse filter into an adjusting vessel.

In the adjusting vessel the cooling is continued, and binder (1) according to the first aspect of the invention (e.g. binder (1) as obtained in Example 1) is transferred by compressed air or a positive displacement pump through a coarse filter into the adjusting vessel.

In one variant of Example 2, additionally, component (X) is added to the adjusting vessel and mixed with the ingredients of the adjusting vessel. The properties of the finished binder (2) such as solid content, viscosity is adjusted according to desired specifications to obtain binder (2).

### Example 3: Coating Application with Formulation According to the Invention

The binder (2) defined in Example 2 was finalized into a coating formulation by mixing 89.60% by weight binder from Example 2 with 8.49% by weight of a pigment dispersion based on TiO₂, 0.16% by weight of di(2-ethylhexyl) adipate (plasticizer (G)), 1.62% by weight of sodium polyacrylate (dispersing agent (H)) and 0.13% by weight of glyoxal (crosslinking agent (I)) such that the final formulation had a solids content of 50% by weight, based on the total amount of the suspension. The suspension was further adjusted to a solids content of 84% by weight by admixing calcium carbonate.

The coating formulation was applied on wood using an appropriate equipment resulting in a coating thickness of 0.3 to 0.6 mm. After this application step, the material was dried with the use of an oven at a temperature of from 55-70° C. for a period of from 3 to 7 minutes. Subsequently, the coated wood was subjected to sanding.

### Example 4: Immersion Test

Wood coated with a commercially available wood-coating composition and wood coated with the coating formulation from Example 3 were immersed for a period of 10 hours in water. The wood coated with the commercially available formulation showed re-emulsification, contrary to the wood coated with the coating formulation from Example 3.

| Product Comparison | Time (h) |
|---|---|
| Conventional Product | 0.5 |
| Coating formulation of Example 3 | 10-12 |

### Example 5: Water Absorption—Karsten Tube Test

The Karsten Tube Penetration Test is a simple test for measuring the degree or water penetration into materials. The test consists of a glass tube filled with water, bonded to the test material with plastiline. Water pressure is then exerted on the surface. A graduated scale indicates, over time, the amount or water penetrated into the surface.

3 days after the coating process of Example 3, a Karsten tube was placed on the substrate and the tube was filled with water. During a period of 72 h the water penetration was measured and reported. The commercial product was completely re-emulsified after 72 hours test whereas the coating formulation of Example 3 showed a water absorption of ≤0.5 ml in the same period, i.e. was not re-emulsified.

| Product Comparison | 24 h | 48 h | 72 h |
|---|---|---|---|
| Conventional Product | 0.5 ml | 1.2 ml | — |
| Coating formulation of Example 3 | 0.1 ml | 0.3 ml | 0.5 ml |
| (formulation according to the invention) | | | |

### Example 6: QUV Test

The QUV test procedure simulates long-term outdoor exposure to sunlight, rain, and dew by exposing materials to alternating cycles of UV-A or UV-B light and moisture at controlled elevated temperatures.

These tests were carried out in a QUV equipment during 72 hours at a temperature of 60° C. During this period, it was alternated cycles of UV-B light (4 hours) and water condensation cycles (4 hours):

| Product Comparison | L | a | b* |
|---|---|---|---|
| Conventional Product 1 | 94.55 | −0.05 | 1.94 |
| After 72 h in QUV test | 89.74 | 0.55 | 6.02 |
| Conventional Product 2 | 93.42 | 0.53 | 2.60 |
| After 72 h in QUV test | 90.12 | 0.77 | 5.89 |
| Coating formulation of Example 3 | 93.33 | −0.11 | 1.34 |
| (formulation according to the invention) | | | |
| After 72 h in QUV test | 92.99 | 0.13 | 1.98 |

In the table, L* indicates lightness, a* is the red/green coordinate, and b* is the yellow/blue coordinate in the CIE LAB color system.

After 72 hours in QUV test, the commercial product showed a higher level of yellowing compared to the inventive coating formulation of Example 3.

1. Binder comprising at least components (A), (B1), optionally (B2), and (C):
(A) a polymer comprising at least the following monomer units:
(A1) at least one monomer comprising styrene units;
(A2) at least one monomer comprising acrylic acid ester units;
(A3) at least one monomer comprising acrylic acid units;
(A4) at least one olefinic monomer comprising amine groups; and
(A5) at least one olefinic surfactant;
(B1) at least one ionic surfactant; and
(B2) optionally at least one non-ionic surfactant; and
(C) an aqueous liquid.

2. Binder according to claim 1, wherein polymer (A) comprises at least the following monomer units:
30.0 to 50.0 % by weight of monomer (A1);
45.0 to 60.0 % by weight of monomer (A2); 0.1 to 8.0 % by weight of monomer (A3); 0.1 to 8.0 % by weight of monomer (A4); 0.1 to 7.0 % by weight of monomer (A5);
based on the total amount of (A) (=100 % by weight).

3. Binder according to claim 1, wherein component (B1) is selected from: salts of fatty acids, alkylbenzene sulfonates, alkylsulfonates, fatty alcohol sulfates, alkylether sulfates, or mixtures thereof;
wherein component (B2) is selected from: polyalkylene oxide carboxylic acid esters, ethoxylated fatty alcohols, poloxamers, alkyl polysaccharides, or mixtures thereof.

4. Binder according to claim 1, wherein the binder comprises from
40 to 60% by weight of (A);
0.1 to 5.0% by weight of (B1);
0.0 to 5.0% by weight of (B2)
35 to 70% by weight of (C);
based on the total amount of the binder (=100% by weight).

5. Binder according to claim 1, wherein the binder further comprises (D):
(D) a compound comprising a silane group.

6. Binder according to claim 5, wherein compound (D) is present in an amount of from 0.1 to 2% by weight based on the total amount of polymer (A) (=100% by weight).

7. Binder according to claim 1, wherein the binder further comprises components (E), (F) and optionally one or more of components (X)
(E) a polymer of at least one monomer comprising vinyl acetate monomer units (E1);
(F) at least one protective colloid; and
(X) optionally at least one tannin inhibitor.

8. Binder according to claim 7, wherein polymer (E) is a homopolymer of vinyl acetate monomers (E1); wherein protective colloid (F) is a non-ionic water-soluble polymer;
wherein tannin inhibitor (X) is selected from reactive pigments, salt solutions derived therefrom, or a mixture thereof.

9. Binder according to claim 7, wherein the binder comprises
30 to 50% by weight of (A);
2 to 6% by weight of (E);
0.5 to 10% by weight of (F);
0.02 to 4.0% by weight of (B1);
0.0 to 4.0% by weight of (B2);
35 to 65% by weight of (C);
based on the total amount of the binder (=100% by weight).

10. A formulation for coating wood-containing substrates, the formulation comprising:
(1) one or more binders comprising at least components (A), (B1), optionally (B2), and (C):
(A) a polymer comprising at least the following monomer units:
(A1) at least one monomer comprising styrene units;
(A2) at least one monomer comprising acrylic acid ester units;
(A3) at least one monomer comprising acrylic acid units;
(A4) at least one olefinic monomer comprising amine groups; and
(A5) at least one olefinic surfactant;
(B1) at least one ionic surfactant; and
(B2) optionally at least one non-ionic surfactant; and
(C) an aqueous liquid;
wherein the formulation comprises further
(G) at least one plasticizer;
(H) at least one dispersing agent;
(I) at least one crosslinking agent;
optionally at least one pigment;
(K) optionally at least one filler;
(L) optionally at least one thickener;
(X) optionally at least one tannin inhibitor; and
(Y) optionally at least one additive.

11. Formulation according to claim 10, wherein plasticizer (G) is selected from phthalates, adipates of C₈ to C₁₂ alcohols, or mixtures thereof;
wherein dispersing agent (H) is a polymeric dispersant, selected from polyphosphates, styrene-maleinates, polyacrylates, or mixtures thereof;
wherein crosslinking agent (I) is selected from formaldehyde, polycarboxylic acids, or dialdehydes, or mixtures thereof;
wherein pigment (J) is a white pigment;
wherein filler (K) is selected from earth alkali metal salt of carbonate, sulfate, phosphate, clay, kaolin, or mixtures thereof;
wherein thickener (L) is selected from cellulosics, hydrophobically modified alkali swellable emulsions (HASE), hydrophobically modified polyurethanes (HEUR), hydrophobically modified polyethers (HMPE), alkali swellable emulsions (ASE) specialty clays, or mixtures thereof;
wherein additive (Y) is selected from wetting agents, defoamers, biocides, rheological modifiers, UV stabilizers, or mixtures thereof;
wherein tannin inhibitor (X) is selected from reactive pigments, salt solutions derived therefrom, or a mixture thereof.

12. Formulation according to claim 10, wherein the formulation comprises
from 10 to 60% by weight of the one or more binders;
wherein the formulation comprises further
0.01 to 5.0% by weight of (G);
0.1 to 5.0% by weight of (H);
0.01 to 5.0% by weight of (I);
0 to 20% by weight of pigment (J)
0 to 80% by weight of filler (K),
0 to 4.0% by weight of thickener (L);
0 to 20% by weight of inhibitor (X);
0 to 5.0% by weight of additive (Y);
10 to 60% by weight of (C);
based on the total amount of the formulation (=100% by weight).

13. Method of making a binder as defined in claim 1 comprising: emulsion polymerization of compounds (A1) to (A5) in presence of component (B1), optionally component (B2), and component (C).

14. Method of making a formulation as defined in claim 10 comprising mixing the one or more binders with at least one plasticizer (G), at least one dispersing agent (H), at least one crosslinking agent (I), and optionally with one or more of at least one pigment (J), at least one filler (K), at least one thickener (L), at least one tannin inhibitor (X), and at least one additive (Y).

15. Method of treating a wood-containing substrate, comprising at least step (S1) followed by steps (S2) and (S3):
(S1) contacting a wood-containing substrate with the formulation defined in claim 10;
(S2) heat-treatment of the wood-containing substrate obtained after step (S1); and
(S3) finishing the wood-containing substrate obtained after step (S2).

16. Wood-containing substrate comprising at least the binder as defined in claim 1.

17. Method of treating a wood-containing substrate, comprising at least step (S1) followed by steps (S2) and (S3):
(S1) contacting a wood-containing substrate with the binder as defined in claim 1;
(S2) heat-treatment of the wood-containing substrate obtained after step (S1); and
(S3) finishing the wood-containing substrate obtained after step (S2).

18. Wood-containing substrate comprising at least the formulation as defined in claim 10.
